(19) United States
(12) Patent Application Publication
(10) Pub. No.: US 2006/0080637 A1
(43) Pub. Date: Apr. 13, 2006

(54) System and method for providing malware information for programmatic access

(75) Inventors: Randal P. Treit, Monroe, WA (US); Jose G. Pelland, Duvall, WA (US); Michael A. Treit JR., Bellevue, WA (US); Michael Kramer, Yonkers, NY (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/963,753

(22) Filed: Oct. 12, 2004

(51) Int. Cl. G06F 9/44

(52) U.S. Cl. 717/101

(57) ABSTRACT

A malware Web service provides malware information to client computing devices. A client computing device formulates a malware information query, and submits the query to the malware Web service. The malware information query specifies criteria relating to a plurality of searchable fields in a malware data store. Upon receiving the malware information query, the malware Web service retrieves the requested information from the malware data store, formats the requested information, and returns the information to the requesting client computing device. In one embodiment, the requested malware information is formatted according to a predetermined schema, such that the returned results are programmatically consumable by a computing device.

### FIELD OF THE INVENTION

The present invention relates to computer security information, and in particular, a system and method for providing malware information for programmatic access and consumption by computer systems.

### BACKGROUND OF THE INVENTION

An unfortunate aspect of computer systems generally, and in particular, of computer systems connected to other computer systems via a network such as the Internet, is that computer systems are constantly under attack. These attacks come in a variety of different forms including computer viruses and worms, denial of service attacks, computer exploits (i.e., software that takes advantage of vulnerabilities or weaknesses in the computer system to gain unauthorized access or control of the computer system), exploitation or abuse of legitimate computer system features, and the like. Other forms of computer attacks come in the form of unwanted software, including both spyware and adware, often surreptitiously placed on the user's machine for the purpose of displaying advertising or obtaining marketing information about the user, thereby compromising both the user's privacy and/or computer's performance. For purposes of the present invention, all of these various types of computer attacks will all be generally referred to as malware.

It is frequently a cat and mouse game for a computer owner to stay ahead of the latest malware that circulates the various networks. Most computer users subscribe to anti-virus software in order to protect their computer systems. Some users, especially business users, not only use anti-virus software, but also frequently rely on other forms of protection, such as proxies, firewalls, and the like, to protect their computer systems from malware attacks.

As those skilled in the art will appreciate, generally speaking, firewall administrators are charged with restricting access to protected networks to authorized external systems. Unfortunately, it is often a guessing game as to what policies a firewall administrator must enforce in order to secure the protected networks. Quite frequently, the firewall administrator relies on updates and reports generated by various security interest sources, including anti-virus software companies, to determine the protection/policies that should be implemented on the firewall. Unfortunately, the information from security interest sources is intended to be read by human eyes, such that the firewall administrator must translate the information into security policies. Usually, this process is tedious, time-consuming, and inefficient.

Most security interest sources, such as anti-virus companies, publish information regarding malware for user information/consumption. For the home user, such information is most often educational and, as such, is written in generalities without specific details. For example, most anti-virus software providers provide a service whereby a user may visit their Web site, query the service regarding the latest malware circulating on the Web, its potential for destruction, as well as steps for recovering from an “infection.” Clearly, this type of information is geared for human consumption and education. In other words, it is difficult to translate typical anti-virus information into protective policies.

Furthermore, while users, including firewall administrators, can obtain malware information from security interest sources regarding certain known malware, unfortunately, no facility currently exists for users to make a directed query for malware that affects/attacks particular networking aspects. For example, for various business reasons, a corporation may request that its firewall administrator open up a range of communication ports to external systems. However, prior to doing so, it would be very useful for the firewall administrator to know (or find out) whether any malware affects the targeted range of ports, what are the liabilities caused by the malware related with opening those ports, and what can be done to mitigate their effects. Of course, one way that a firewall administrator, or any computer user in general, can determine the type of activities that may or may not be considered “safe,” is to sift and sort through all of the information regarding malware that can be retrieved. Unfortunately, at the frequency with which new malware is released, this is not a practical solution.

In light of the above-identified issues, what is needed is a system and method for querying a database of malware information regarding a variety of specific aspects. What is also needed is a system and method that returns malware information to a requesting party in a computer-consumable form. The present invention addresses these and other issues found in the prior art.

### SUMMARY OF THE INVENTION

In accordance with aspects of the present invention, a computer system for providing malware information in response to client queries is provided. The system includes a malware data store that stores malware information. The malware information is stored as records of individual malware, each record having a plurality of independently searchable fields. The system also includes a malware Web service. The malware Web service is coupled to the malware data store, and also coupled to a communications network. The malware Web service communicates with client computers over the communications network. The malware Web service receives malware information requests from client computers. In response to a malware information query, the malware Web service retrieves malware information from the malware data store, formats the retrieved malware information according to a predetermined format, and returns the formatter malware information to the requesting client computer.

In accordance with further aspects of the present invention, a network system for delivering malware information to client network devices is presented. The network system comprises a malware Web service for responding to malware information queries. The network system further comprises a plurality of client network devices coupled to the malware Web service over a communications network. The malware Web service, in response to a malware information query received from a client network device retrieves malware information from a malware data stores according to a plurality of criteria specified in the malware information query. The malware Web service formats the retrieved malware information according to a predetermined format and returns the formatted malware information to the requesting client network device.

In accordance with still further aspects of the present invention, a method for processing malware information queries from clients devices over a communication network is presented. At a malware Web service communicatively coupled to a plurality of client devices, a malware information query is received. The malware information query is formatted according to a predetermined schema for requesting malware information. Malware information is retrieved from a malware data store according to criteria corresponding to a plurality of searchable fields specified in the malware information query. The retrieved information is formatted according to a predetermined schema for returning malware information, and the formatted malware information is returned to the client device.

In accordance with additional aspects of the present invention, a computer-readable medium bearing computer-executable instructions, is presented. When the computer-executable instructions are executed on a malware Web service communicatively coupled to a plurality of client devices over a communication network, they carry out a method for processing malware information queries from clients devices over a communication network. At the malware Web service, a malware information query is received. The malware information query is formatted according to a predetermined schema for requesting malware information. Malware information is retrieved from a malware data store according to criteria corresponding to a plurality of searchable fields specified in the malware information query. The retrieved information is formatted according to a predetermined schema for returning malware information, and the formatted malware information is returned to the client device.

According to still additional aspects of the present invention, a method for generating malware information at a malware Web service, communicatively coupled to a plurality of client devices, usable for programmatic consumption by a client device, is presented. A malware information query is received from a client device. The malware information query identifies the requested malware information to be returned. Malware information is retrieved from a malware data store according to the malware information query. The retrieved malware information is formatted according to a predetermined schema for returning malware information, such that the malware information is programmatically consumable. The formatted malware information is returned to the client device.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary networked environment suitable for implementing aspects of the present invention;

FIG. 2 is a block diagram illustrating an exemplary exchange between a user computer and the Web service of FIG. 1 in responding to a user initiated query;

FIG. 3 is a block diagram illustrating an exemplary exchange between a computer and the Web service of FIG. 1 in responding to computer initiated service queries; and

FIG. 4 is a block diagram illustrating an exemplary routine, implemented on a Web service, for responding to client queries.

### DETAILED DESCRIPTION

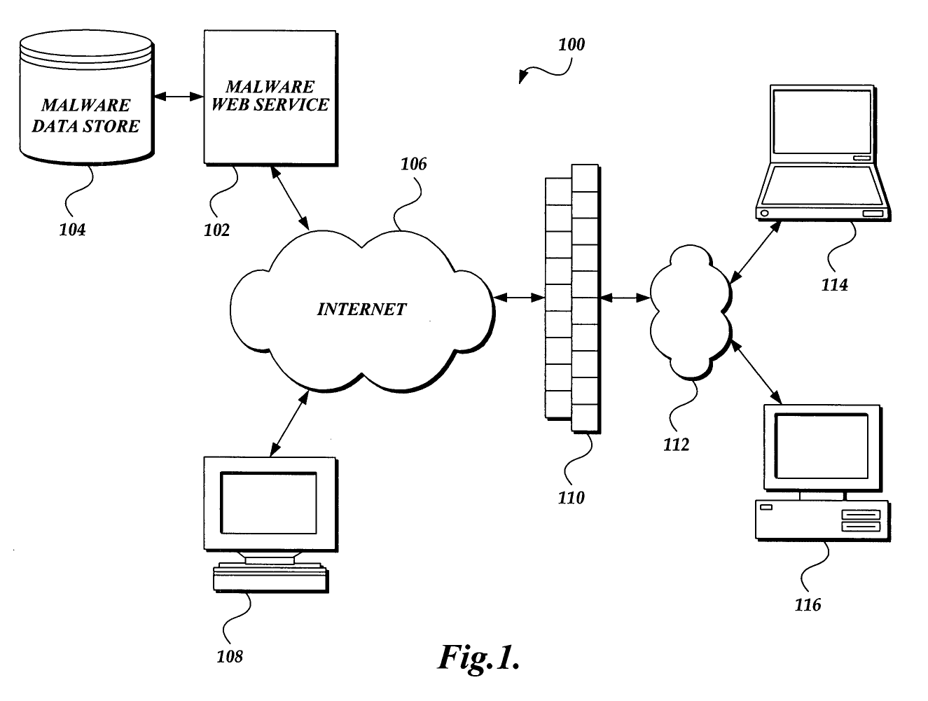

As mentioned above, FIG. 1 is a pictorial diagram illustrating an exemplary networked environment 100 suitable for implementing aspects of the present invention. As shown in FIG. 1, the exemplary networked environment 100 includes a malware Web service 102. The exemplary networked environment 100 also includes a malware data store 104 that contains the malware information available to clients via the malware Web service 102. Thus, the malware Web service 102 receives and responds to client requests for information related to malware that is stored in the malware data store 104. According to aspects of the present invention, the malware data store 104 stores information relating to individual malware entities as malware records, and each record is comprised of at least one, and typically a plurality, of fields. The fields of the records are independently searchable, meaning that information within that field may be examined without examining the entire malware entity's record.

The malware Web service 102 may be implemented on a variety of computing devices. For example, the malware Web service 102 may be implemented on the so-called desktop computer, but the present invention is not so limited. Other alternative computing devices include, but are not limited to, mainframe and mini-computers, and laptops, as well as a distributed system comprising a plurality of computing devices.

According to one embodiment of the present invention, and as illustrated in FIG. 1, the malware Web service 102 and the malware data store 104 are separate entities, i.e., the malware Web service is connected to, and associated with, a malware data store. However, in an alternative embodiment, the malware Web service 102 may include a malware data store 104. Accordingly, the illustrated networked environment 100 of FIG. 1 should be viewed as exemplary, and not construed as limiting upon the present invention. Additionally, the malware data store 104 may be implemented in a variety of configurations. For example, in one embodiment, the malware data store 104 is implemented as a relational database. In an alternative embodiment, the malware data store 104 is implemented as a flat file database. Still further, the malware data store 104 may be implemented in a distributed manner, over a plurality of computing devices and databases.

According to one embodiment of the present invention, the malware Web service 102 is available to receive and respond to client requests via a network, such as the Internet 106. While the malware Web service 102 ultimately responds to malware information queries/requests issued by a computer, for purposes of the present discussion, the term clients refers to those computers that initiate queries at the direction of a computer user, and those computers that have been programmed, either periodically or otherwise, to automatically submit queries to the malware Web service. As shown in FIG. 1, there are at least three clients, including computers 108, 114, and 116. As will be described in more detail below, firewall 110 may also potentially be a client of the malware Web service 102.

Computer 108 is illustrated as connected to the Internet 106, while computers 114 and 116 are illustrated as connected to the Internet via a local network 112, and a protective firewall 110. The indirect access of computers 114 and 116 to the malware Web service 102 are typical of business computers/networks, as well as many other computer and network environments. Those skilled in the art will recognize that quite often a firewall is implemented on a computing system, or administered by a computer. As such, firewall 110 may be a computing system which could query the malware Web service 102 and receive and process responses to its queries.

According to aspects of the present invention, requests made to the malware Web service 102, and responses returned from the malware Web service, are formatted as extensible markup language (XML) documents, according to a predetermined schema. In regard to requests or queries submitted to the malware Web service 102, there are basically two types: data store informational requests, and malware informational requests. The data store informational requests are those intended to obtain information about the data store, such as, but not limited to, the available fields upon which a client may submit a query to the malware Web service 102, the request and/or response formats, and the like. Alternatively, the malware informational requests are those request malware information from the malware data store 104 according to criteria specified or identified in the request.

With regard to the informational requests, as indicated above, one of the advantages of the present invention of other systems is that a client is able to query the malware Web service 102 based on a variety of factors. These factors are identified as the available, searchable fields returned in response to an informational request. The following table, Table 1, identifies exemplary fields for which a client could submit a request. As can be seen, each field in the table includes a unique identifier, a user-readable field name, a field description, and a field type. However, it should be understood that the elements identified for the above fields are illustrative, and may vary in an actual embodiment. Nevertheless, each field must be identifiable to the malware Web service 102 such that the malware Web service can resolve the intent of the query and perform the corresponding search of the malware data store 104.

TABLE 1

| | | | Field |
|---|---|---|---|
| ID | Field Name | Description | Type |
| 53 | AffectedPort.Max | Maximum port # affected | integer |
| 52 | AffectedPort.Min | Minimum port # affected | integer |
| 54 | AffectedPort.Type | Type of port affected | integer |
| | | (i.e., UDP, TCP) | |
| 39 | Alias.AliasName | Common alias of malware | Text |
| 17 | Analysis.Author | Malware analysis author | Analyst |
| 41 | Author.AuthorName | Name of malware author | Text |
| 42 | Author.Motivation | Motivation (if known) | Text |
| | | for malware | |
| 37 | Variant.Child | Child variant of malware | Text |
| 11 | System.Bulletin | Related OS bulletin | Text |
| | | regarding malware | |
| 49 | Comment.Text | Comment re malware | Text |
| | | from a contributor | |
| 50 | Comment.Contributor | Comment contributor | Text |
| 7 | Malware.Class | Malware classification | Class |
| 2 | Malware.Damage | Perceived damage rating | Integer |
| | | of malware | |
| 1 | Malware.Defense | Defensive action to | Text |
| | | protect from malware | |
| 29 | Malware.Infection | Infection level of malware | Real |
| 30 | Malware.Delivery | Delivery mechanism of malware | Text |
| 31 | Malware.MailSubjet | Mail subject line of malware | Text |
| 22 | Malware.OS | Operating systems affected | Integer |
| | | by malware | |
| 28 | Malware.Trigger | Triggering mechanism of malware | Text |
| 18 | Infection.Registry | Registry entries | RValue |
| | | infected by malware | |
| 19 | Infection.Path | File path of malware executable | URI |
| 14 | System.LatestReleased | Latest released/detected malware | integer |

As those skilled in the art will appreciate, a particular query submitted to the malware Web service 102 could involve any number of fields logically combined according to user wishes. Such combinations allow computer users, security personnel, firewall administrators, and the like, to keep informed of the latest threats posed by malware, and provide recommendations to protect a computer or network from such malware.

As previously mentioned, another aspect of the present invention is that information retrieved from the malware Web service 102 may be used by computer users, as well as used programmatically, i.e., used by a computer to direct subsequent computer actions. As already mentioned, a response returned from the malware Web service 102 will be formatted according to a predetermined format, such as a particular XML schema. By putting the retrieved information into an XML document, values, such as port numbers, indices, and the like, may be easily interpreted in the document. Additionally, those skilled in the art will appreciate that XML documents are user readable, thus easily consumed by a computer user. This could be further aided by client programs designed to arrange, format, and display information in a response for greater user legibility.

With regard to programmatic consumption, because the response is returned in a known format, a computer can be programmed to “consume” specific, relevant information within the document and take appropriate actions based on values within the response. For example, if a response in regard to a particular malware query indicated that a newly released malware affected ports 300-320 in some fashion, a program monitoring such information could extract that information out (because such information is in identifiable locations due to the format of the response) and close, at least temporarily, all access to those ports. Further action could be taken including, but not limited to, closing all access to external networks, sending alerts to administrators, downloading and installing relevant system patches or anti-virus data files, or launching additional programs to handle aspects of the information retrieved. These, and other, programmatic actions are possible when the response to a particular query stores the retrieved information in identifiable locations and in a format that can be programmatically interpreted. As mentioned, the present invention provides such functionality.

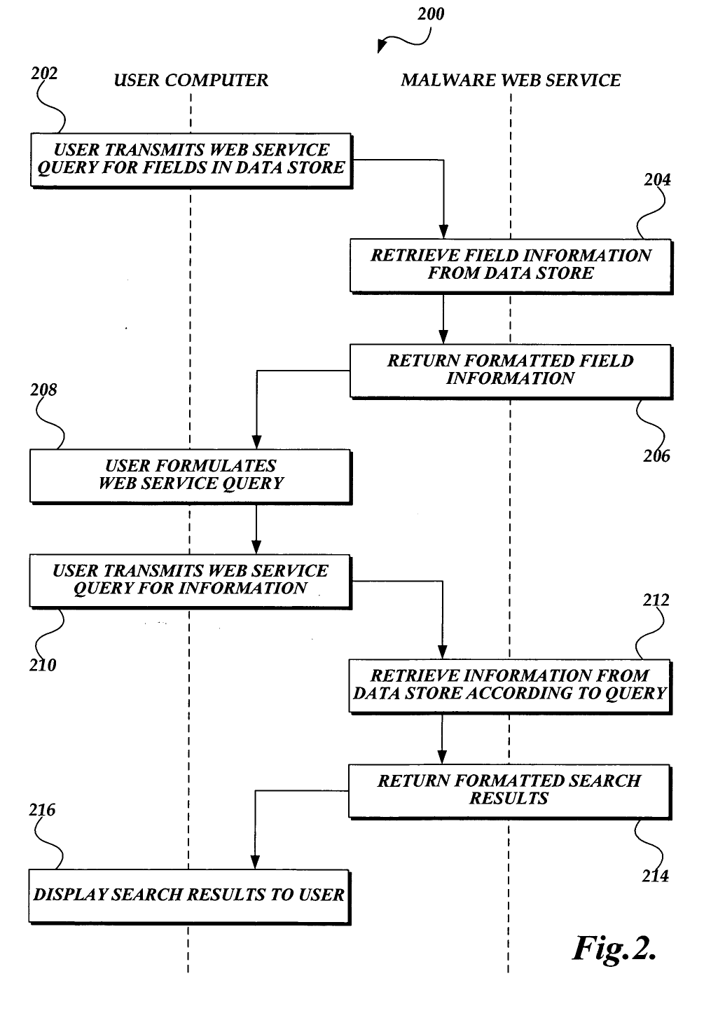

With regard to responding to client requests/queries, FIG. 2 is a block diagram illustrating an exemplary exchange 200 between a user computer, such as computer 108, and the malware Web service 102 of FIG. 1, in responding to user initiated queries. Beginning at event 202, the user, on a client computer 108, creates a Web service query requesting the available, searchable fields in the malware data store 104, and transmits, or posts, the query to the malware Web Service 102. At event 204, according to the Web service query, the malware Web service 102 retrieves the searchable fields available in the malware data store 104. At event 206, the searchable fields, formatted according to a predetermined schema, are returned to the user's computer 108.

At event 208, the user determines/selects the fields to be searched in the malware data store 104. After formulating a second Web service query, the user transmits the second query to the malware Web service 102. At event 210, the malware Web service 102 obtains the query and retrieves information from the malware data store 104 according to the specified search criteria in the second query. As before, at event 214, the results of the search are formatted according to a predetermined schema and returned to the user computer 108. Thereafter, at event 216, the user is displayed the search results.

While the malware Web service 102 may respond to user initiated queries, it will equally respond to pre-programmed and/or periodic queries. For example, a firewall administrator may program the firewall 110, or the computer that implements or administers the firewall, to periodically query the malware Web service 102 for the latest malware, or more particularly, for the latest malware that might affect the particularly configured firewall and network. Furthermore, based on the results, the computer may be preprogrammed to take certain actions, including sending a broadcast notice to a system administrator, shutting down certain ports, and the like.

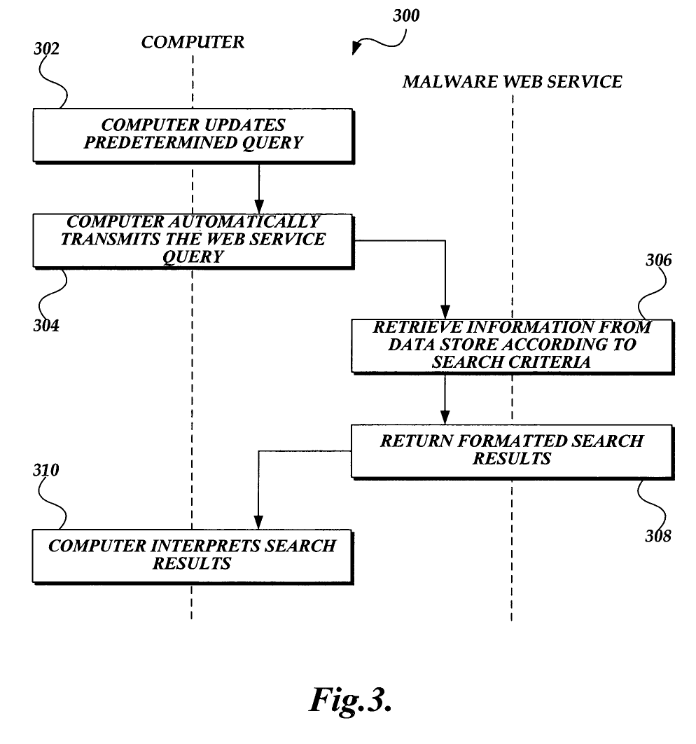

FIG. 3 is a block diagram illustrating an exemplary exchange between a computer and the malware Web service 102 of FIG. 1 in responding to a computer initiated service query. This diagram assumes that the list of available, searchable fields in the malware data store 104 is already available on the computer. Beginning at event 302, the computer optionally updates a predetermined query with specific conditional elements. For example, the computer may update the predetermined query with the date of the latest periodic search in order to identify the malware that has been released since that time, thereby limiting the amount of relevant information that must be subsequently searched and processed.

At event 304, the computer transmits the now updated query to the malware Web service 102. At event 306, the malware Web service 102 retrieves malware information from the malware data store 104 according to the information/criteria specified in the query. At event 308, the malware Web service 102 returns the retrieved information to the requesting computer, formatted according to the predetermined format or schema. Upon receiving the results of the query, the computer interprets the search results and takes any actions as have been preprogrammed onto the computer.

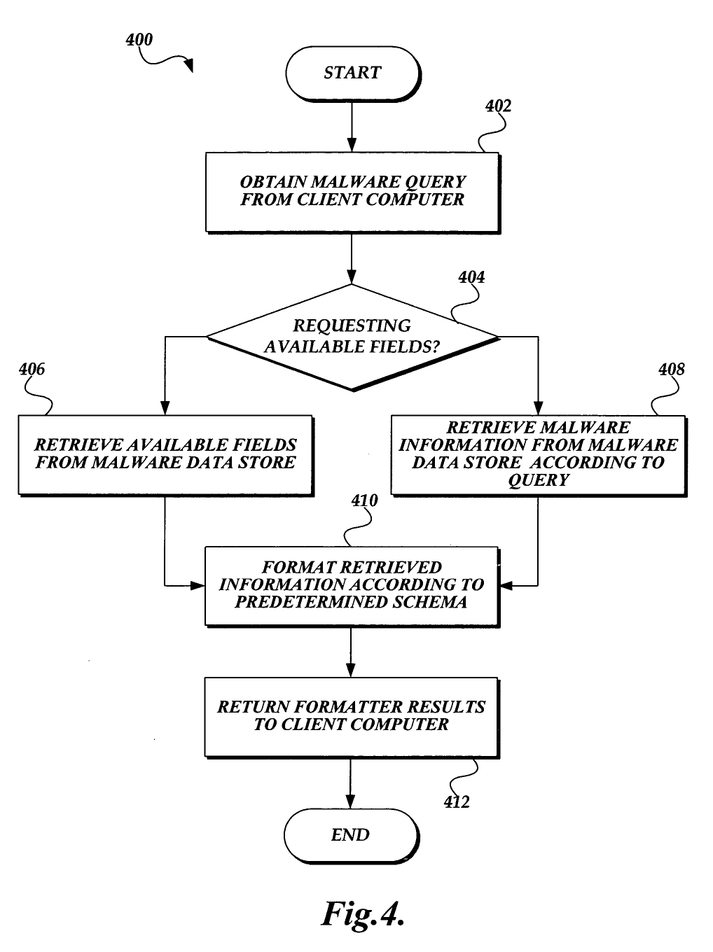

FIG. 4 is a flow diagram illustrating an exemplary routine 400, implemented by a malware Web service 102, for processing malware Web service queries. Beginning at block 402, the malware Web service 102 obtains a Web service query from a client computer. At decision bock 404, a determination is made as to whether the request/query is for available search fields, or whether it is for specific malware information. If the query is a request for available search fields, at block 406, the available search fields are retrieved from the malware data store 104. Alternatively, if the query is for specific malware information, the malware Web service 102 performs the search according to the criteria specified in the Web services query and retrieves the results.

At block 410, the malware Web service 102 formats the retrieved results according to a predetermined format/schema. As mentioned above, in one embodiment, the returned response is an XML document formatted according to a predetermined XML schema. After formatting the results, the malware Web service 102 returns the formatted results to the requesting client computer. Thereafter, the exemplary routine 400 terminates.

While various embodiments, including the preferred embodiment, of the invention have been illustrated and described, it will be appreciated that various changes can be made therein without departing from the spirit and scope of the invention. For example, while the present invention has been described with regard to retrieving malware information, the malware Web service 102 and malware data store 104 may be generalized to respond with programmatically consumable responses to general queries in regard to computer and/or network security issues.

The embodiments of the invention in which an exclusive property or privilege is: claimed are defined as follows:

1. A computer system for providing malware information in response to client queries, the computer system comprising:
a malware data store that stores malware information, wherein the malware information is stored as records of individual malware, each record having a plurality of independently searchable fields; and
a malware Web service, communicatively coupled to the malware data store, and communicatively coupled to a communication network for communicating with client computers, that receives malware information queries for malware information, and in response to each malware information query:
retrieves malware information from the malware data store according to criteria specified in the malware information query;
formats the retrieved malware information according to a predetermined format; and
returns the formatted malware information to the requesting client computer.

2. The computer system of claim 1, wherein the malware Web service formats the retrieved malware information according to a predetermined schema such that the formatted malware information is programmatically consumable by a computing device.

3. The computer system of claim 2, wherein the malware Web service formats the retrieved malware information according to a predetermined XML schema.

4. The computer system of claim 2, wherein the malware information queries received by the malware Web service are formatted according to a predetermined schema for requesting malware information.

5. The computer system of claim 4, wherein the malware information queries received by the malware Web service are formatted according to a predetermined XML schema XML schema.

6. The computer system of claim 4, wherein a malware information query is a malware information query automatically generated by a client computer.

7. A network system for delivering malware information to client network devices, the network system comprising:
a malware Web service for responding to malware information queries from client network devices; and
a plurality of client network devices communicatively coupled to the malware Web service over a communication network;
wherein the malware Web service, in response to a malware information query received from a client network device:
retrieves malware information from a malware data store according to a plurality of criteria specified in the malware information query;
formats the retrieved malware information according to a predetermined format; and
returns the formatted malware information to the requesting client network device.

8. The network system of claim 7, wherein the malware Web service formats the retrieved malware information according to a predetermined schema such that the formatted malware information is programmatically consumable by a client network device.

9. The network system of claim 8, wherein the malware Web service formats the retrieved malware information according to a predetermined XML schema.

10. The network system of claim 8, wherein the malware information queries received by the malware Web service are formatted according to a predetermined schema for requesting malware information.

11. The network system of claim 10, wherein the malware information queries received by the malware Web service are formatted according to a predetermined XML schema XML schema.

12. The network system of claim 10, wherein a malware information query is a malware information query automatically generated by a client network device.

13. A method for processing malware information queries from client devices over a communication network, the method comprising:
at a malware Web service communicatively connected to a plurality of client devices over the communication network:
receiving a malware information query from a client device, the malware information query formatted according to a predetermined schema for requesting malware information;
retrieving malware information from a malware data store according to criteria corresponding to a plurality of searchable fields specified in the malware information query;
formatting the retrieved malware information according to a predetermined schema for returning malware information; and
returning the formatted malware information to the client device.

14. The method of claim 13, wherein formatting the retrieved malware information according to a predetermined schema for returning malware information comprises formatting the retrieved malware information according to a predetermined schema such that the formatted malware information is programmatically consumable by a client device.

15. The method of claim 14, wherein the predetermined schema for returning malware information is an XML schema.

16. The method of claim 14, wherein the malware information queries received by the malware Web service are formatted according to a predetermined schema for requesting malware information.

17. The method of claim 16, wherein the malware information queries received by the malware Web service are formatted according to a predetermined XML schema XML schema for requesting malware information.

18. The method of claim 14, wherein a malware information query is a malware information query automatically generated by a client device.

19. A computer-readable medium bearing computer-executable instructions, which, when executed on a malware Web service communicatively connected to a plurality of client devices over the communication network, carry out a method for processing malware information queries from client devices, the method comprising:
receiving a malware information query from a client device, the malware information query formatted according to a predetermined schema for requesting malware information;
retrieving malware information from a malware data store according to a plurality of searchable fields identified in the malware information query;
formatting the retrieved malware information according to a predetermined schema for returning malware information; and
returning the formatted malware information to the client device.

20. The method of claim 19, wherein formatting the retrieved malware information according to a predetermined schema for returning malware information comprises formatting the retrieved malware information according to a predetermined schema such that the formatted malware information is programmatically consumable by a client device.

21. A method for generating malware information usable for programmatic consumption by a client device in response to a query from the client device over a communication network, the method comprising:
at a malware Web service communicatively connected to a plurality of client devices over a communication network:
receiving a malware information query from a client device, the malware information query identifying the requested malware information to be returned;
retrieving malware information from a malware data store according to the malware information query;
formatting the retrieved malware information according to a predetermined schema for returning malware information, such that the malware information is programmatically consumable; and
returning the formatted malware information to the client device.
